(19) United States
(12) Patent Application Publication
(10) Pub. No.: US 2011/0142471 A1
(43) Pub. Date: Jun. 16, 2011

(54) FUSER AND TEMPERATURE CONTROL METHOD FOR THE FUSER

(75) Inventor: Tadashi Noguchi, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/960,660

(22) Filed: Dec. 6, 2010

Related U.S. Application Data
(60) Provisional application No. 61/285,414, filed on Dec. 10, 2009.

(51) Int. Cl. G03G 15/20

(52) U.S. Cl. 399/69

(57) ABSTRACT

According to one embodiment, a fuser including a heating unit configured to heat a toner to be fused on a sheet medium and the sheet medium, a temperature detecting unit configured to detect temperature of the heating unit, and a control unit configured to stop power feed to the heating unit according to the temperature of the heating unit detected by the temperature detecting unit and a condition until completion of the fusing specified in advance.

### CROSS-REFERENCE TO RELATED APPLICATIONS

This application is based upon and claims the benefit of priority from: U.S. Provisional Application No. 61/285,414 filed on Dec. 10, 2009; the entire contents of each of which are incorporated herein reference.

### FIELD

Embodiments described herein relate generally to an image forming apparatus and fuser unit use in the image forming apparatus.

### BACKGROUND

A toner (a visualizing agent) moves to a sheet medium on the basis of image information and is integrated with the sheet medium. The sheet medium (integrated with the toner) is a hard copy.

A fuser unit integrates the toner with the sheet medium.

### BRIEF DESCRIPTION OF THE DRAWINGS

A general architecture that implements the various features of the embodiments will now be described with reference to the drawings. The drawings and the associated descriptions are provided to illustrate embodiments and not to limit the scope of the embodiments.

FIG. 1A is an exemplary diagram showing an example of an MFP, according to an embodiment;

FIG. 1B is an exemplary diagram showing an example of an MFP, according to an embodiment;

FIG. 2 is an exemplary diagram showing an example of a fuser of the MFP according to an embodiment;

FIG. 3 is an exemplary diagram showing an example of a fuser of the MFP according to an embodiment;

FIG. 4 is an exemplary diagram showing an example of fusing temperature conditions of the MFP according to an embodiment;

FIGS. 5A, 5B and 5C are exemplary diagrams showing an example of fusing temperature conditions (a lamp driving signal, heating roller temperature, and pressing roller temperature) according to an embodiment;

FIG. 6 is an exemplary diagram showing an example of temperature control of the fuser according to an embodiment;

FIG. 7 is an exemplary diagram showing an example of temperature control of the fuser according to an embodiment;

FIG. 8 is an exemplary diagram showing an example of temperature control of the fuser according to an embodiment;

FIG. 9 is an exemplary diagram showing an example of temperature control of the fuser according to an embodiment;

FIG. 10 is an exemplary diagram showing an example of temperature control of the fuser according to an embodiment;

FIG. 11 is an exemplary diagram showing an example of temperature control of the fuser according to an embodiment;

FIG. 12 is an exemplary diagram showing an example of a fuser of the MFP according to an embodiment; and

FIG. 13 is an exemplary diagram showing an example of a fuser of the MFP according to an embodiment.

### DETAILED DESCRIPTION

In general, according to an embodiment, a fuser comprising: a heating unit configured to heat a toner to be fused on a sheet medium and the sheet medium; a temperature detecting unit configured to detect temperature of the heating unit; and a control unit configured to stop power feed to the heating unit according to the temperature of the heating unit detected by the temperature detecting unit and a condition until completion of the fusing specified in advance.

Embodiments will now be described hereinafter in detail with reference to the accompanying drawings.

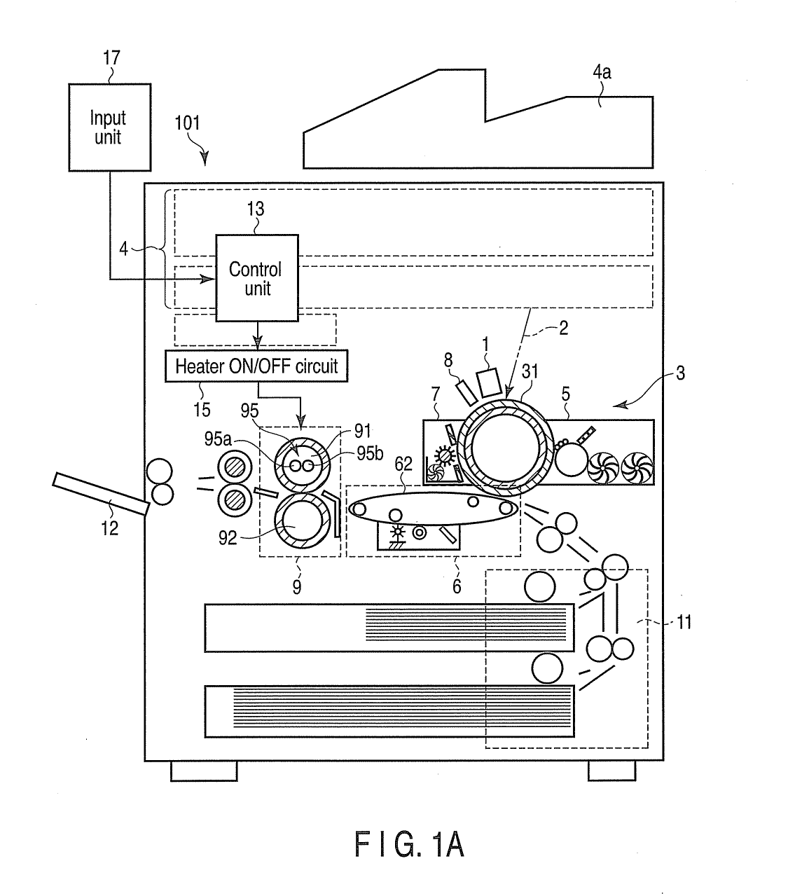

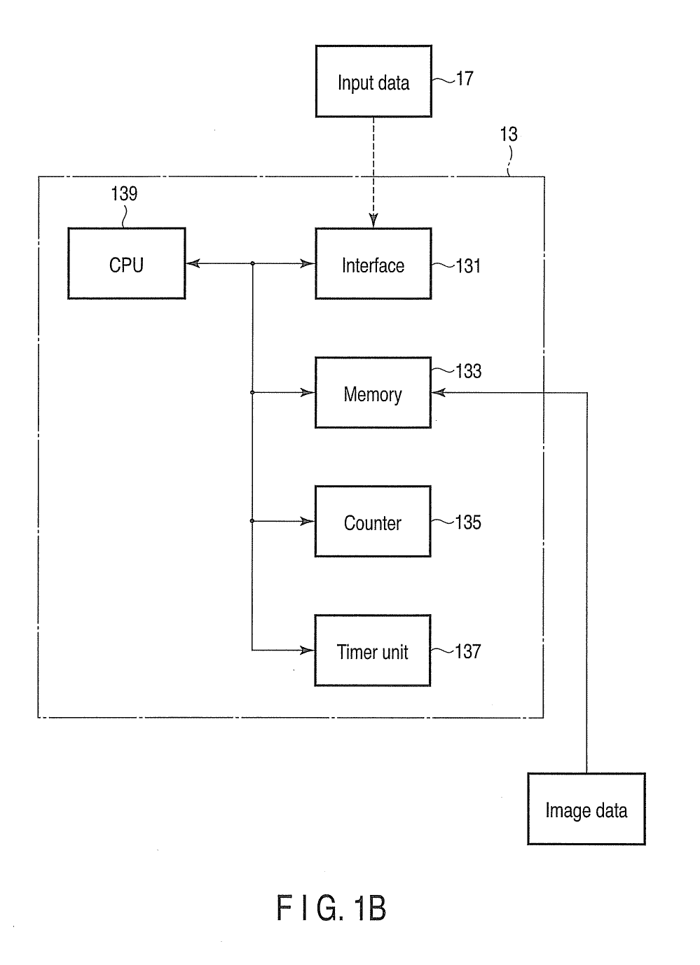

An image forming apparatus (MFP: Multi-Functional Peripheral) 101 shown in FIG. 1A includes at least a charging unit 1, a writing (exposing) unit 2, an image forming (latent image forming, developing, transferring, and cleaning) unit 3, a document reading unit 4 with an automatically feeding unit (ADF) 4a, a developing unit 5, a transfer unit 6, a cleaning unit 7, a charge removing unit 8, and a fuser unit 9.

The charging unit 1 gives charges having predetermined polarity (in this example, “− (minus)”) to a photoconductive layer on the surface of an image bearing member, for example, a cylindrical drum 31 included in the image forming unit 3 explained below. The image bearing member is not limited to the cylindrical drum and may be an endless belt or a cylindrical drum member located on the inner side of the endless belt.

The writing (exposing) unit 2 irradiates exposure light, for example, a laser beam, light intensity of which changes according to image information as a target of image formation, on the photoconductive layer on the surface of the cylindrical drum (hereinafter referred to as photoconductive drum) 31 charged by the charging unit 1 and changes the potential of the photoconductive layer. A latent image is formed in a section where the potential is changed. The image information is provided by the document reading unit 4 explained below or an external apparatus such as a PC (Personal Computer) or a facsimile. The photoconductive drum 31 has an external diameter of, for example, 100 mm and includes a photoconductive layer 33 on the surface of a metal substrate (hollow aluminum) 32 as indicated by an example shown in FIG. 3. The photoconductive layer includes, for example, an organic photoconductive member (OPC).

The image forming (latent image forming, developing, transferring, and cleaning) unit 3 conveys a toner image obtained by developing (visualizing) the latent image with toner (a visualizing agent) provided by the developing device 5 to the transfer unit 6, the cleaning unit 7, and the charge removing unit 8 according to the rotation of the image forming unit 3. The photoconductive drum 31 rotates, for example, clockwise (in a CW (clockwise) direction) at predetermined speed.

The document reading unit 4 includes a document reading device. The document reading device includes, for example, a CCD sensor with 600 dpi (dots per inch)/7500 pixels (a total number of pixels in a longitudinal direction thereof) and converts image information as a reflected light signal of irradiated light into an electric signal.

The developing unit 5 includes a magnet roller and a developing sleeve locates on the outer circumference of the magnet roller and rotates on the outer circumference. The magnet roller selectively provides toner, which moves on the surface of the developing sleeve according to the rotation of the developing sleeve, to the latent image on the surface of the photoconductive drum 31 while magnetically attracting the toner. A space between the developing sleeve and the photoconductive drum 31 is managed by a guide roller set in contact with the surface of the photoconductive drum 31. The developing sleeve is formed of a nonmagnetic material such as stainless steel or aluminum.

The transfer unit (the peeling unit) 6 moves, with an electric field provided by a transfer roller, the toner image onto a sheet conveyed by a sheet conveying belt 62 (toners forming the toner image subjected to the electric field provided by the transfer roller move to the sheet). A peeling unit separates the toner (the toner image) and the sheet from the surface of the photoconductive drum.

In the cleaning unit 7, include a waste toner and foreign matter storing unit and stores a transfer residual toner (a waste toner), fiber pieces of a sheet, a surface coating agent, or the like scraped off by a removing mechanism such as a brush member (or a brush roller having a cylindrical brush) or a foreign matter conveyed together with the sheet.

The charge removing unit 8 resets the potential of the photoconductive layer on the surface of the image bearing member 31 to an initial state before the charging by the charging unit 1 (removes residual charges on the photoconductive member). The charge removing unit 8 includes an LED array in which LED elements configured to output red light having wavelength longer than, for example, 770 nm are arranged in an axis direction of the drum 31.

The image forming apparatus 101 further includes a paper feeding unit 11 configured to feed a sheet to the transfer unit 6 of the image forming unit 3 and a paper discharge unit 12 configured to receive a sheet on which a toner image is fixed by the fixing unit 9. The image forming apparatus 101 forms a toner image corresponding to image information provided by the document reading unit 4 or an apparatus such as a PC (Personal Computer) or a facsimile.

Specifically, when image formation is instructed from an operation unit or an external apparatus not shown in the figure, process control by the image forming unit 3 and fixing temperature control by the fixing unit 9 are started according to the control by the control unit 13. A copy output or a printout (a print output) is output by, for example, latent image formation, development, transfer, and cleaning in the image forming unit 3, movement of the toner image to the sheet from the paper feeding unit 11 by the transfer and peeling unit 6, and sheet conveyance control according to image information input by the document reading unit 4 or the external apparatus.

As indicated by an example shown in FIG. 1B, a control unit 13 includes an interface 131 configured to receive an input value from a control input unit (an operation unit) 17 to which the number of output images (outputs) and output image magnification corresponding to image information acquired by the ADF 4a and the reading unit 4, the size of a sheet medium, a printing start signal, and the like can be input, a memory 133 configured to store the input numerical value data (input value), the acquired (input) image information, and the like, a counter 135 configured to count the remaining number of sheets to which the image is output, a timer unit 137 configured to calculate time until the end of the image output referring to the remaining number of sheets to which the image is output stored by the counter 135, and a main control device (a CPU) 139.

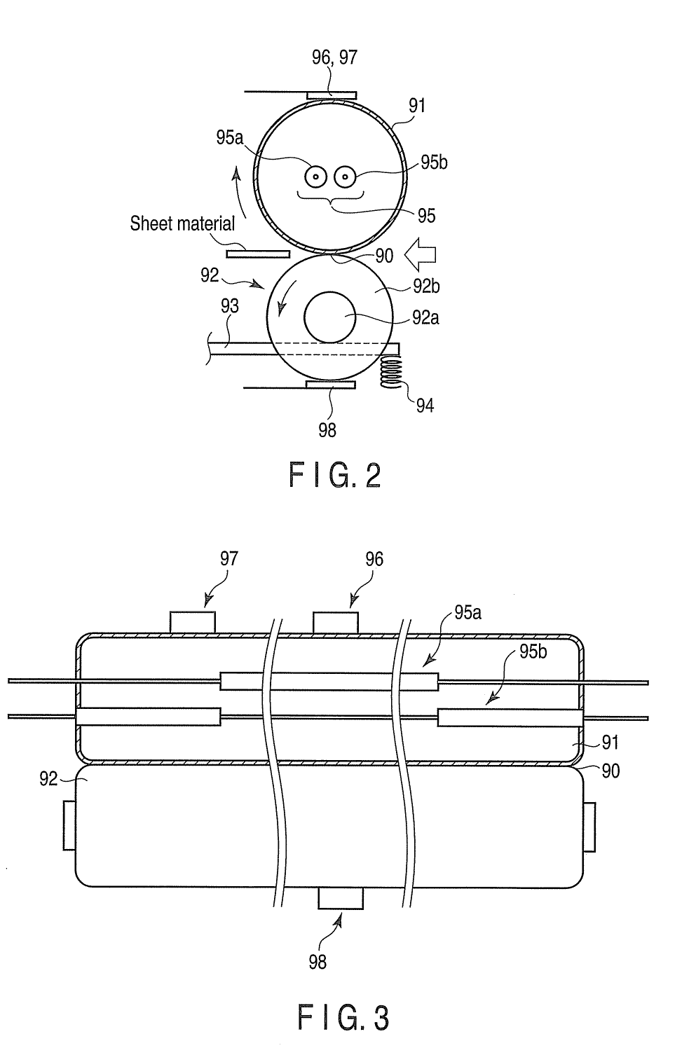

As indicated by an example shown in FIG. 2, the fuser unit 9 includes a first roller 91 (e.g., φ30 mm) and a second roller 92 (e.g., φ30 mm) configured to provide a nip 90. The outer circumferential surface of one roller is brought into contact with the outer circumferential surface of the other roller by a spring 94 for applying pressure to a roller supporting member 93 configured to support the first roller 91 or the second roller 92. In the following explanation, the first roller 91 is defined as a heating roller and the second roller 92 is defined as a pressing roller.

The material of the heating roller 91 is, for example, aluminum. The thickness of the heating roller 91 is, for example, 0.8 mm. The surface of the heating roller 91 is coated with a release layer of Teflon (registered trademark; tetrafluoroethylene resin) or the like.

In the pressing roller 92, a cored bar 92a is covered with an elastic layer 92b formed of, for example, silicon rubber or fluorine rubber.

A heating device 95 is located on the inner side of the heating roller 91. The heating device 95 includes two heater lamps, for example, halogen lamps in a heating source. Each of the lamps is, for example, 600 W.

As indicated by an example shown in FIG. 3, each of lamps 95a and 95b has a different light distribution adjusted to a heating position necessary for each of the rollers. Each of the lamps 95a and 95b is turned on at predetermined timing by a heater driving (ON/OFF) circuit 15 (the circuit 15 feeds power to the lamps 95a and 95b).

In the heating roller 91, thermistors (temperature sensors) 96 and 97 for detecting the temperature of the surface of the roller are respectively located generally in the center and an end in a longitudinal direction of the heating roller 91. A thermistor (a temperature sensor) 98 is located generally in the center in a longitudinal direction of the pressing roller 92.

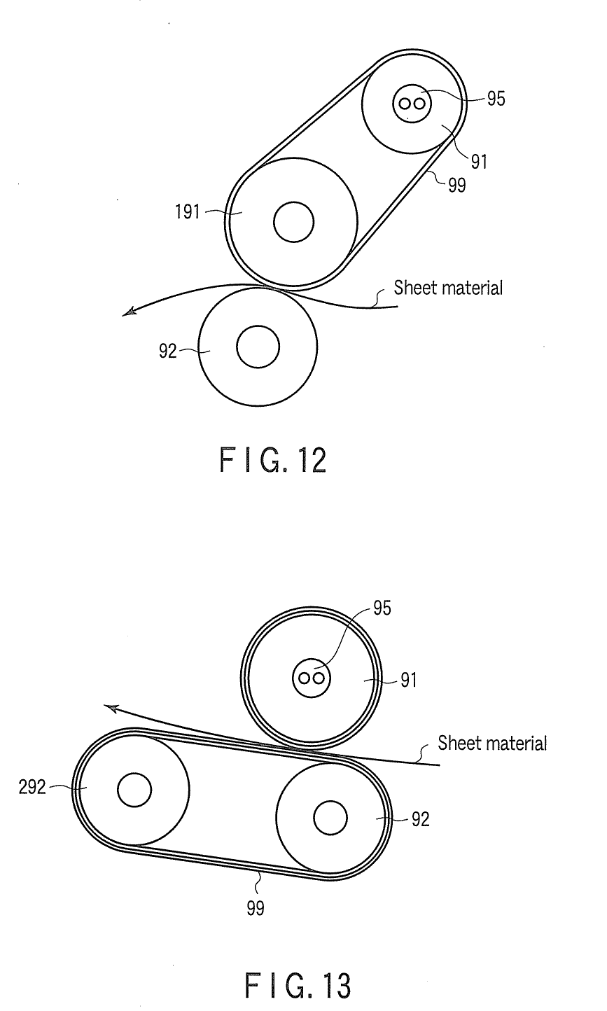

As shown in FIG. 12, it is also possible to adopt a configuration in which a belt member 99 in contact with the pressing roller 92 and a belt roller 191 forming the nip 90 between the pressing roller 92 and the belt member 99 are used and the heating roller 91 is not in direct contact with the pressing roller 92. In this case, the heating device 95 can be located on the outer circumference side of the belt member 99.

Further, it is also possible to adopt a configuration in which a belt member 99 in contact with the heating roller 91 and a belt roller 292 forming the nip between the heating roller 91 and the belt member 99 are used and the heating roller 91 is not in direct contact with the pressing roller 9, shown in FIG. 13.

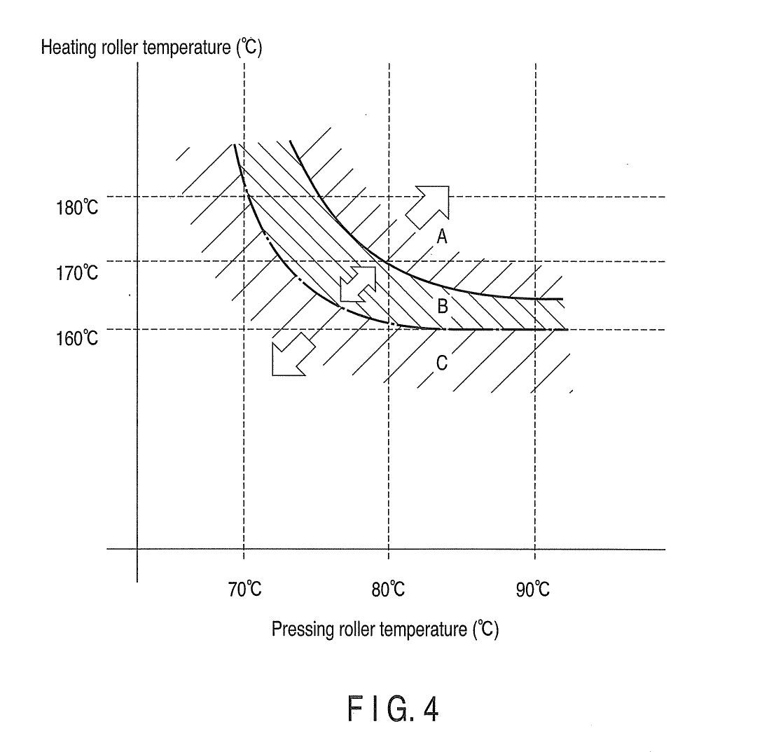

FIG. 4 represents a fusing OK (acceptable) temperature region specified by heating roller temperature and pressing roller temperature.

If the temperatures of the heating roller 91 and the pressing roller 92 are within the fusing OK (acceptable) region indicated by reference sign A in FIG. 4, image deficiency such as a fusing failure does not occur. In FIG. 4, a region indicated by reference sign B is a temperature region in which a fusing failure could occur under a specific condition. For example, it is desirable to stop a fusing operation in image formation on a sheet medium having thickness larger than 100 g/m² and full-color image output having a thick toner layer and use the temperature in the temperature region indicated by reference sign A as the temperatures of the heating roller 91 and the pressing roller 92.

During image formation on continuous sheets or only one sheet, i.e., during a fusing operation, when there is no (instruction or input of) following image formation, the temperatures of the heating roller 91 and the pressing roller 92 at the time of fusing end (sheet medium discharge) have a degree enabling fusing of a toner image if the next sheet medium is present. Therefore, during a continuous fusing operation, even if power feed to the lamps is stopped at a point when the remaining number of sheets on which the toner image is fused reaches a predetermined number, it is possible to fuse the toner image on the last sheet medium. When there is no following image formation, in the latter half of ready (when a standby state without an instruction (input) of image formation continues for a fixed period, after a predetermined period elapses from a point when the MFP 101 changes to a ready state), a power saving (sleep) mode is set in order to suppress power consumption.

Therefore, if the temperatures of the heating roller 91 and the pressing roller 92 can be returned to the inside of the region B or the region A in FIG. 4 within a predetermined time at a point when the next image formation is instructed, it is possible to stop power feed to the heater lamps 95a and 95b in the heating roller 91 prior to shift to the sleep mode.

Specifically, in time for stopping the power feed to the lamps in the latter half of the ready, return limit temperature D from instruction (input) of image formation until a sheet medium bearing a toner is conveyed to the nip 90 of the fuser unit 9 can be calculated by the following Formula (1):

D=C−A×B=150° C. (1)

A: return time from lamp-off to fusing OK (ready) <3 sec>

B: rising temperature=10° C./sec

C: lamp-off start temperature=180° C.

Therefore, judging from “C” and “D”, temperature attenuation (fall) of 30° C. is allowed. Time in which temperature falls 30° C. depends on image processing speed (the number of sheets on which a toner image is fused per unit time) of the MFP 101. For example, when the time is 90 sec, during the ready, the power feed to the lamps 95a and 95b can be stopped for 90 sec at the maximum (the circuit 15 temporarily stops the power feed to the lamps).

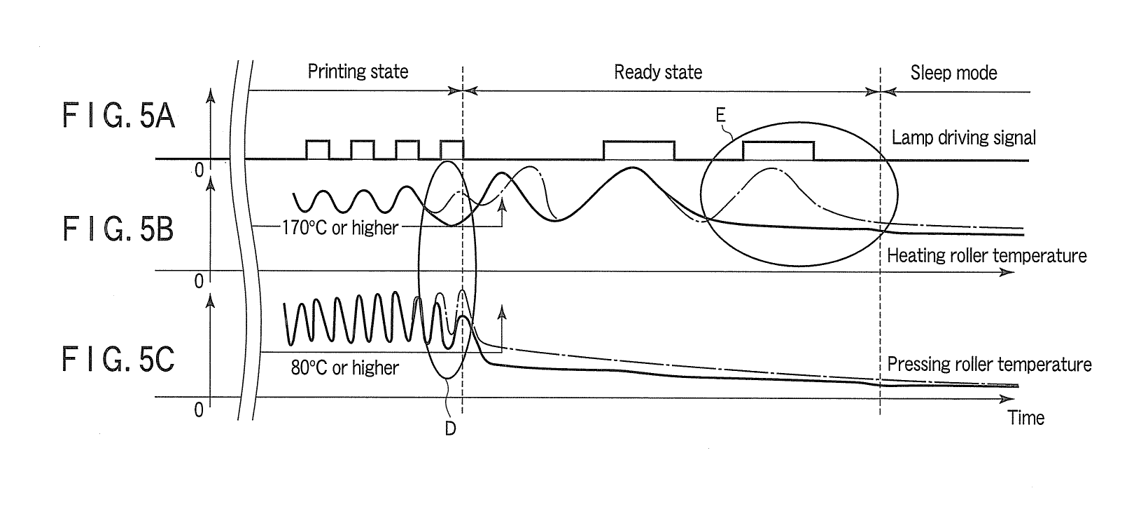

This means that, in each of a region indicated by D (immediately before fusing end) and a region indicated by E (the latter half of the ready) shown in FIGS. 5A, 5B, and 5C, power consumed by the lamps 95a and 95b can be reduced compared with general control indicated by a dotted line. FIGS. 5B and 5C respectively show the temperatures of the rollers 91 and 92. However, power consumption is generally equal to a value obtained by integrating, with time, curves indicated by the figures.

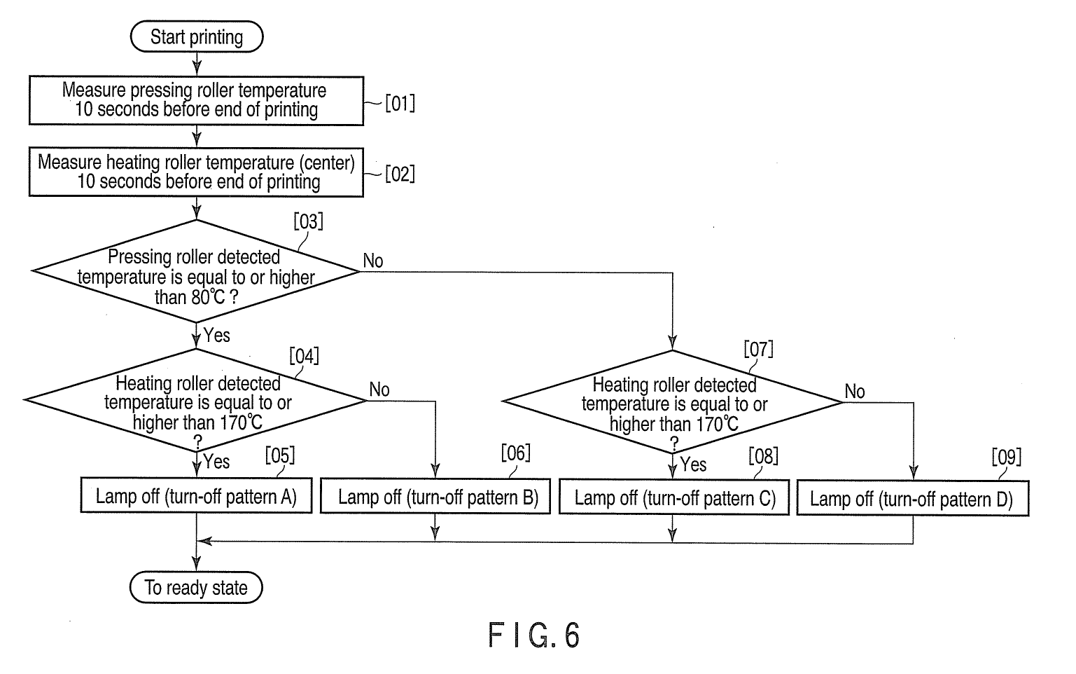

FIG. 6 shows an example of temperature control of the heater lamps shown in FIGS. 5B and 5C. In FIG. 6, it is possible to control lighting time and duty of the lamps before shift to the ready using the temperature (center) of the heating roller 91, i.e., the output of the thermistor 96 and the temperature of the pressing roller 92, i.e., the output of the thermistor 98.

Specifically, during image formation on a predetermined number of sheets following a printing start signal, i.e., fusing of a toner image on sheet media, the temperature of the pressing roller 92 is measured 10 seconds before the end of the printing [01] and the temperature (center) of the heating roller 91 is measured 10 seconds before the end of the printing [02]. A determination condition “10 seconds before the end of the printing” is arbitrarily set by the timer unit 177 and the CPU 179 on the basis of the remaining number of sheets on which the toner image is fused (which can be calculated from the number of output sheets input to the input unit 17) or the number of remaining sheets on which the toner image is fused and the size of the sheets.

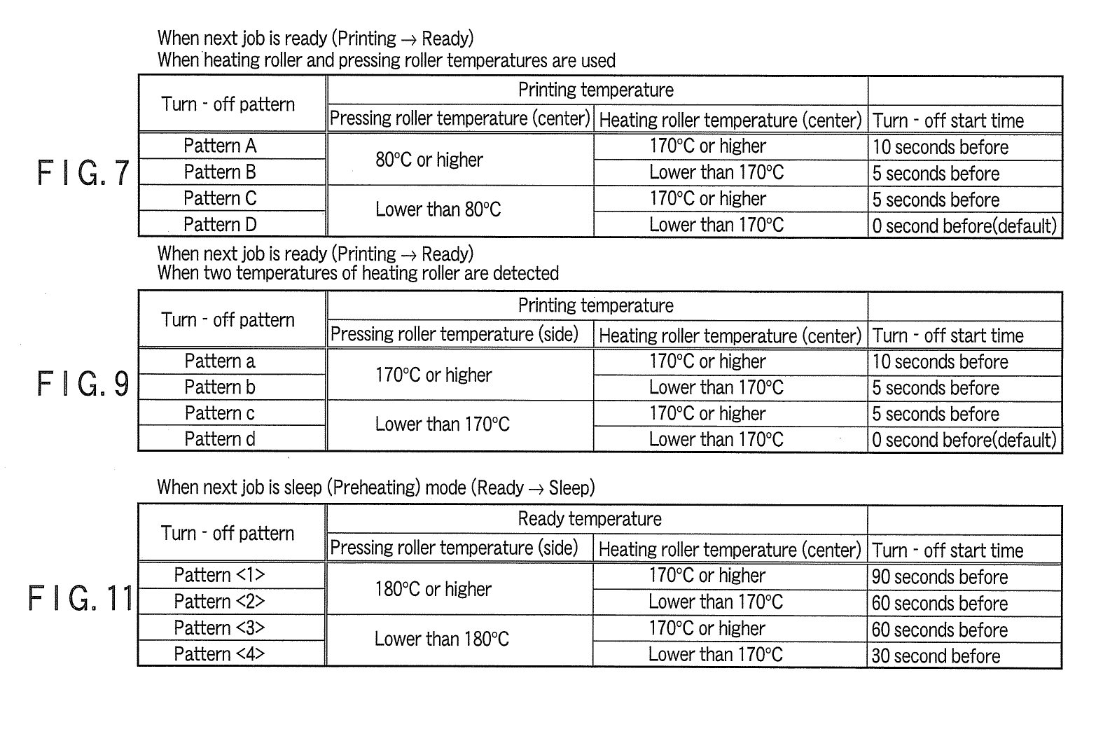

If the measured temperature of the pressing roller 92 is equal to or higher than 80° C. [03—Yes] and the temperature (center) of the heating roller 91 is equal to or higher than 170° C. [04—Yes], the output of the circuit 15 is turned off according to a pattern A shown in FIG. 7 (lamp-off (a turn-off pattern A)) [05].

If the measured temperature of the pressing roller 92 is equal to or higher than 80° C. [03—Yes] and the temperature (center) of the heating roller 91 is lower than 170° C. [04—No], the output of the circuit 15 is turned off according to a pattern B shown in FIG. 7 (lamp-off (a turn-off pattern B)) [06].

If the measured temperature of the pressing roller 92 is lower than 80° C. [03—No] and the temperature (center) of the heating roller 91 is equal to or higher than 170° C. [07—Yes], the output of the circuit 15 is turned off according to a pattern C shown in FIG. 7 (lamp-off (a turn-off pattern C)) [08].

If the measured temperature of the pressing roller 92 is lower than 80° C. [03—No] and the temperature (center) of the heating roller 91 is lower than 170° C. [07—No], the output of the circuit 15 is turned off according to a pattern D shown in FIG. 7 (lamp-off (a turn-of pattern D: default)) [09].

As it is evident from FIG. 7, in the patterns A to D shown in FIG. 6, timing for turning off the lamps 95a and 95b is different.

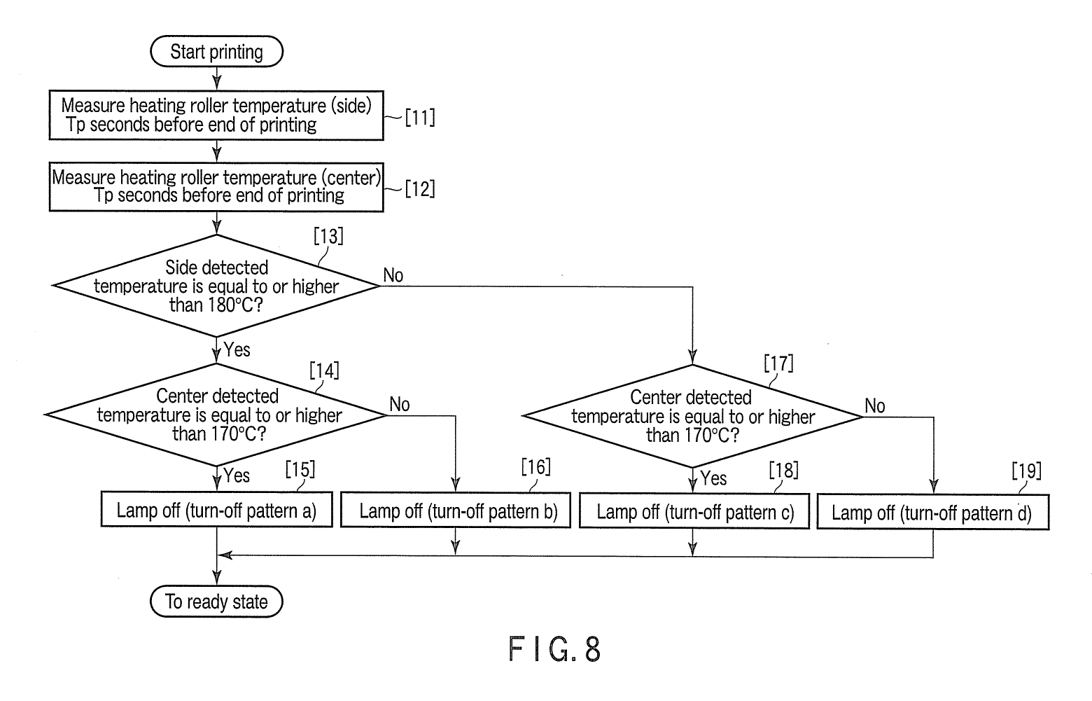

FIG. 8 shows an example of the temperature control of the heater lamps shown in FIGS. 5B and 5C. In FIG. 8, it is possible to control lighting time and duty of the lamps before shift to the ready using the temperature (center) of the heating roller 91, i.e., the output of the thermistor 96 and the temperature (end) of the heating roller 91, i.e., the output of the thermistor 97.

Specifically, during image formation on a predetermined number of sheets following the start of printing, i.e., fusing of a toner image on sheet media, the temperature (side) of the heating roller 91 is measured Tp seconds before the end of the printing [11] and the temperature (center) of the heating roller 91 is measured Tp seconds before the end of the printing [12]. A determination condition “Tp seconds before the end of the printing” is arbitrarily set on the basis of the remaining number of sheets on which the toner image is fused or the number of remaining sheets on which the toner image is fused and the size of the sheets.

If the measured temperature (side) of the heating roller 91 is equal to or higher than 180° C. [13—Yes] and the temperature (center) of the heating roller 91 is equal to or higher than 170° C. [14—Yes], the output of the circuit 15 is turned off according to a pattern a shown in FIG. 9 (lamp-off (a turn-off pattern a)) [15].

If the measured temperature (side) of the heating roller 91 is equal to or higher than 180° C. [13—Yes] and the temperature (center) of the heating roller 91 is lower than 170° C. [14—No], the output of the circuit 15 is turned off according to a pattern b shown in FIG. 9 (lamp-off (a turn-off pattern b)) [16].

If the measured temperature (side) of the heating roller 91 is lower than 180° C. [13—No] and the temperature (center) of the heating roller 91 is equal to or higher than 170° C. [17—Yes], the output of the circuit 15 is turned off according to a pattern c shown in FIG. 9 (lamp-off (a turn-off pattern c)) [18].

If the measured temperature (side) of the heating roller 91 is lower than 180° C. [13—No] and the temperature (center) of the heating roller 91 is lower than 170° C. [17—No], the output of the circuit 15 is turned off according to a pattern d shown in FIG. 9 (lamp-off (a turn-of pattern d: default)) [19].

As it is evident from FIG. 9, in the patterns a to d shown in FIG. 8, timing for turning off the lamps 95a and 95b is different.

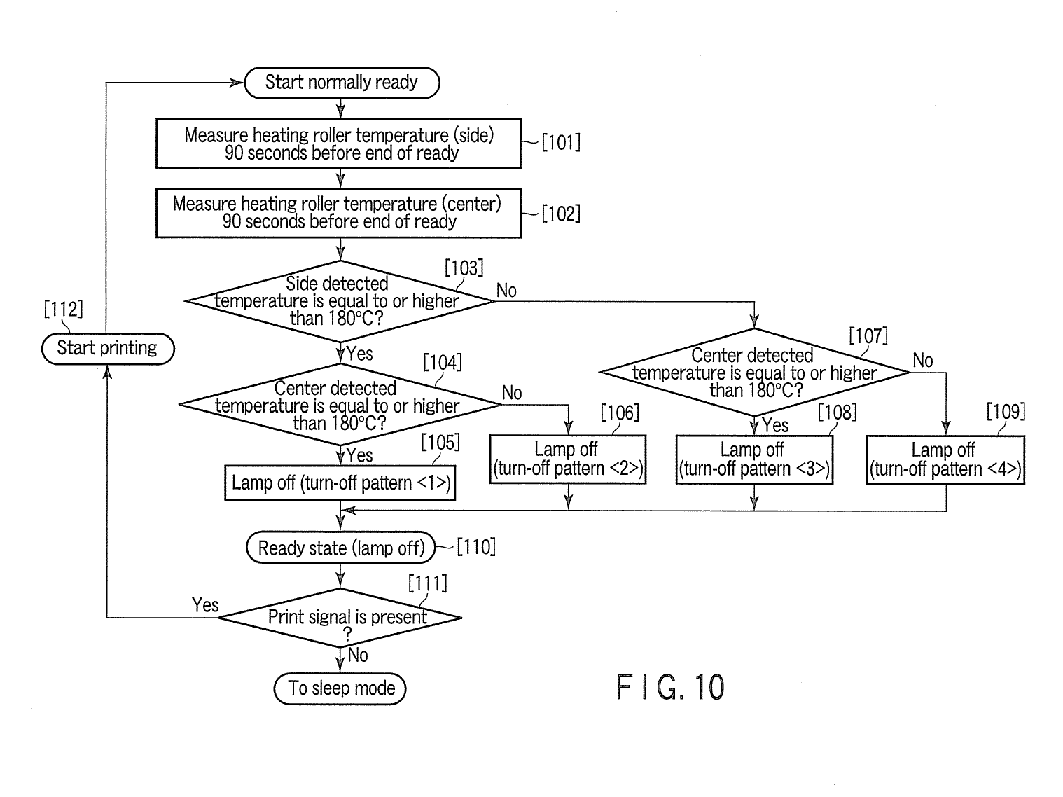

FIG. 10 shows an example of the temperature control of the heater lamps shown in FIGS. 5B and 5C. In FIG. 10, it is possible to control lighting time and duty of the lamps before shift to the ready using the temperature (center) of the heating roller 91, i.e., the output of the thermistor 96 and the temperature (end) of the heating roller 91, i.e., the output of the thermistor 97.

Specifically, during image formation on a predetermined number of sheets following the start of printing, i.e., fusing of a toner image on sheet media, the temperature (side) of the heating roller 91 is measured 90 seconds before the end of the printing [101] and the temperature (center) of the heating roller 91 is measured 90 seconds before the end of the printing [102].

If the measured temperature (side) of the heating roller 91 is equal to or higher than 180° C. [103—Yes] and the temperature (center) of the heating roller 91 is equal to or higher than 180° C. [104—Yes], the output of the circuit 15 is turned off according to a pattern <1> shown in FIG. 11 (lamp-off (a turn-off pattern <1>)) [105].

If the measured temperature (side) of the heating roller 91 is equal to or higher than 180° C. [103—Yes] and the temperature (center) of the heating roller 91 is lower than 180° C. [104—No], the output of the circuit 15 is turned off according to a pattern <2> shown in FIG. 11 (lamp-off (a turn-off pattern <2>)) [106].

If the measured temperature (side) of the heating roller 91 is lower than 180° C. [103—No] and the temperature (center) of the heating roller 91 is equal to or higher than 180° C. [107—Yes], the output of the circuit 15 is turned off according to a pattern <3> shown in FIG. 11 (lamp-off (a turn-off pattern <3>)) [108].

If the measured temperature (side) of the heating roller 91 is lower than 180° C. [103—No] and the temperature (center) of the heating roller 91 is lower than 180° C. [107—No], the output of the circuit 15 is turned off according to a pattern <4> shown in FIG. 11 (lamp-off (a turn-of pattern <4>)) [109].

As it is evident from FIG. 11, in the patterns <1> to <4> shown in FIG. 10, timing for turning off the lamps 95a and 95b is different.

Therefore, during the ready state (lamp-off time) [110], when the start of printing is instructed (a printing signal is input) [111—Yes], image formation is performed according to the start of the printing [112]. The temperature of the heater lamps can return to normal temperature in the ready state in time until a sheet medium bearing a toner image output as a visible image reaches the nip 90 of the fuser unit 9.

By adopting such a configuration, when a sufficient fusing ratio can be secured even if power feed to the heating device is stopped in a fusing process for fusing the toner image on the sheet medium, it is possible to reduce power consumption by turning off the heating device under a predetermined condition.

When there is no instruction (input) of following image formation, it is possible to turn off power feed to the heating device prior to the shift to the standby (ready) state or the power saving (sleep) mode following the standby state while maintaining a condition enabling return to fuse able temperature within a fixed time. Therefore, it is possible to reduce power consumption in two stages.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A fuser comprising:
a heating unit configured to heat a toner to be fused on a sheet medium and the sheet medium;
a temperature detecting unit configured to detect temperature of the heating unit; and
a control unit configured to stop power feed to the heating unit according to the temperature of the heating unit detected by the temperature detecting unit and a condition until completion of the fusing specified in advance.

2. The fuser of claim 1, wherein the condition until the completion of the fusing is time until the completion of the fusing.

3. The fuser of claim 1, wherein the condition until the completion of the fusing is a remaining number of sheet media until the completion of the fusing.

4. The fuser of claim 1, wherein the condition until the completion of the fusing is a temperature difference between temperature in a center of a longitudinal direction of the heating unit and temperature at an end in the longitudinal direction of the heating unit.

5. The fuser of claim 4, wherein the condition until the completion of the fusing includes the temperature difference between the temperature in the center of the longitudinal direction of the heating unit and the temperature at the end in the longitudinal direction of the heating unit and a case in which a following image forming instruction is made after a predetermined time.

6. The fuser of claim 5, further comprising a pressing unit configured to form a nip between the pressing unit and the heating unit and apply predetermined pressure to the sheet medium.

7. The fuser of claim 6, wherein the condition until the completion of the fusing is time until the completion of the fusing.

8. The fuser of claim 6, wherein the condition until the completion of the fusing is a remaining number of sheet media until the completion of the fusing.

9. The fuser of claim 6, wherein the condition until the completion of the fusing is a temperature difference between temperature in a center of a longitudinal direction of the heating unit and temperature in a center in a longitudinal direction of the pressing unit.

10. A method to fuse a visualizing agent on a sheet medium comprising:
heating the visualizing agent to be fused on the sheet medium and the sheet medium; and
stopping power feed for heating according to detected temperature of a heating unit and a fuse completion condition specified in advance.

11. The method of claim 10, wherein the fuse completion condition includes time until the completion of the fusing.

12. The method of claim 10, wherein the fuse completion condition includes a remaining number of sheet media until the completion of the fusing.

13. The method of claim 10, wherein the fuse completion condition includes a temperature difference between temperature in a center of a longitudinal direction of the heating unit and temperature at an end in the longitudinal direction of the heating unit.

14. The method of claim 10, further comprising applying pressure to the visualizing agent and the sheet medium heated by the heating unit.

15. The method of claim 14, wherein the fuse completion condition includes time until the completion of the fusing.

16. An image forming apparatus comprising:
a toner image forming unit configured to supply a toner to an output image and form a toner image;
a toner image moving unit configured to move the formed toner image to a sheet medium;
a heating unit configured to heat the sheet medium and melt the toner image;
a pressing unit configured to apply pressure to the sheet medium and the melted toner image;
a temperature detecting unit configured to detect temperature of the heating unit or the pressing unit; and
a control unit configured to stop power feed to the heating unit according to the temperature of the heating unit or the pressing unit detected by the temperature detecting unit and a remaining number of times of movement of the toner image to the sheet medium.

17. The apparatus of claim 16, wherein the control unit stops the power feed to the heating unit according to a temperature difference between temperature in a center of a longitudinal direction of the heating unit and temperature at an end in the longitudinal direction of the heating unit and the remaining number of times of movement of the toner image to the sheet medium.

18. The apparatus of claim 16, wherein the control unit stops the power feed to the heating unit according to a temperature difference between temperature in a center of a longitudinal direction of the heating unit and temperature at an end in the longitudinal direction of the heating unit.

19. The apparatus of claim 16, wherein the control unit stops the power feed to the heating unit according to a temperature difference between temperature in a center of a longitudinal direction of the heating unit and temperature in a center in a longitudinal direction of the pressing unit.
